(19) United States
(12) Patent Application Publication
(10) Pub. No.: US 2007/0103711 A1
(43) Pub. Date: May 10, 2007

(54) Apparatus and method of automatically modifying print settings

(75) Inventor: Hisataka Funakawa, Hoi-gun (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/589,892

(22) Filed: Oct. 31, 2006

(30) Foreign Application Priority Data
Nov. 8, 2005 (JP) 2005-323787

(51) Int. Cl. G06F 3/12

(52) U.S. Cl. 358/1.13; 358/1.1

(57) ABSTRACT

An apparatus of automatically modifying print settings is provided comprising a receiving portion for receiving data set with the print setting information, a registering portion into which the print setting information is registered, a print setting modifying portion for modifying the print setting information of the received data to the registered print setting information, and a transmitting portion for transmitting the data of which the print setting information is modified by the print setting modifying portion to a printer.

This application claims priority under 35 U.S.C.§119 to Japanese Patent Application No. 2005-323787 filed on Nov. 8, 2005, the entire disclosure of which is incorporated herein by reference in its entirety.

### BACKGROUND OF THE INVENTION

1. Field of the Invention

The present invention relates to an apparatus and a method of automatically modifying the print settings which are applicable to a terminal apparatus such as a personal computer provided with data receiving and transmitting functions or an image forming apparatus such as a printer or a printing-featured copying machine.

2. Description of the Related Art

The following description sets forth the inventor's knowledge of related art and problems therein and should not be construed as an admission of knowledge in the prior art.

Before an attached file such as an image data is attached to an e-mail and transmitted together over a communicating means, it is drafted and edited with the use of a relevant application software (referred to as simply an application hereinafter) installed in a personal computer or any other device which also determines the settings of the print setting information and commands for printing.

Further, depending on application which is used for preparing the file data, the print setting information is systematically saved together with the file data at the time of data saving. Therefore, when the print setting information is modified and saved before transmitted for printing at the transmitter side, and the file data is transmitted through a transmitting means without canceling the modification of the print setting information , the print setting information is received in the modified state by the receiver side.

Accordingly, when the action of printing is commanded by a receiver without concerning the print settings, the printing action will be carried out in a manner not desired by the receiver.

Disclosed in Japanese Patent Laid-open Publication No. 2003-99216 is a technique for, during producing of the print data, examining whether or not the printer driver currently selected by a terminal apparatus is coincident with a printer driver by which the print setting information is saved in the file. In this disclosure, when the two printer driver mentioned above are not coincident, the printer driver at the terminal apparatus is initialized with default print settings. On the contrary, the two printer driver mentioned above are coincident, the print setting information of the file are reflected in the printer driver selected by the terminal apparatus.

However, the above-mentioned prior art is intended to reflect the print settings of the file on the settings of the printer driver in the terminal apparatus at the generation of the printing data. Once the settings have been modified, their modified settings are transmitted or received. The prior art fails to eliminate such a drawback that the printing action is conducted with the modified settings which are not desired by the receiver.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide an apparatus of automatically modifying print settings arranged capable of, when the action of printing is commanded by a receiver without being conscious of the print settings of the data, carrying out the printing action in the manner desired by the receiver.

Among other potential advantages, some embodiments can provide a method of automatically modifying the print settings which, when the action of printing is commanded by the receiver without being conscious of the print settings, allowing the printing action to be carried out as desired by the receiver.

According to a first aspect of the preferred embodiment of the present invention, an apparatus of automatically modifying print settings comprising:
a receiving portion for receiving data set with the print setting information;
a registering portion into which the print setting information is registered;
a print setting modifying portion for modifying the print setting information of the received data to the registered print setting information; and
a transmitting portion for transmitting the data of which the print setting information is modified by the print setting modifying portion to a printer.

According to a second aspect of the preferred embodiment of the present invention, an apparatus of automatically modifying print settings comprising:
a registering portion into which the print setting information for a destination is registered;
a print setting modifying portion for modifying the print setting information of data to be transmitted to the destination to the registered print setting information for the destination; and
a transmitting portion for transmitting the data of which the print setting information is modified by the print setting modifying portion to an external apparatus at the destination.

According to a third aspect of the preferred embodiment of the present invention, a method of automatically modifying print setting comprising the steps of:
receiving data set with the print setting information;
modifying the print setting information of the received data to the print setting information which is registered into a registering portion; and
transmitting the data of which the print setting information is modified to a printer.

According to a fourth aspect of the preferred embodiment of the present invention, a method of automatically modifying the print setting information comprising the steps of:
modifying the print setting information of data to be transmitted to a destination to a print setting information for the destination which is registered into a registering portion; and
transmitting the data of which the print setting information is modified to the destination.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram showing an electrical arrangement of an apparatus of automatically modifying print settings according to one embodiment of the present invention;

FIG. 2 is a diagram showing an example of a structure of a data file;

FIG. 3 is a diagram showing an input screen at the registration of print setting information;

FIG. 4 is a flowchart showing a procedure of registering the print setting information;

FIG. 5 is a flowchart showing a procedure of modifying the print setting information to a data in an attached file at the timing of receipt of an e-mail;

FIG. 6 is a flowchart showing a procedure of modifying the print setting information at the timing of saving the data in the attached file of the e-mail into a storage;

FIG. 7 is a flowchart showing a procedure of modifying the print setting information at the timing of releasing a command for printing the data in the attached file of the e-mail;

FIG. 8 is a table showing settings of the print setting information for each destination registered into the print setting information register;

FIG. 9 is a flowchart showing a procedure of modifying the print setting information of the data in the attached file at the timing of transmitting the e-mail; and

FIG. 10 is a flowchart showing a procedure of modifying the print setting information at the timing of reading the data to be attached to the e-mail from the storage.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

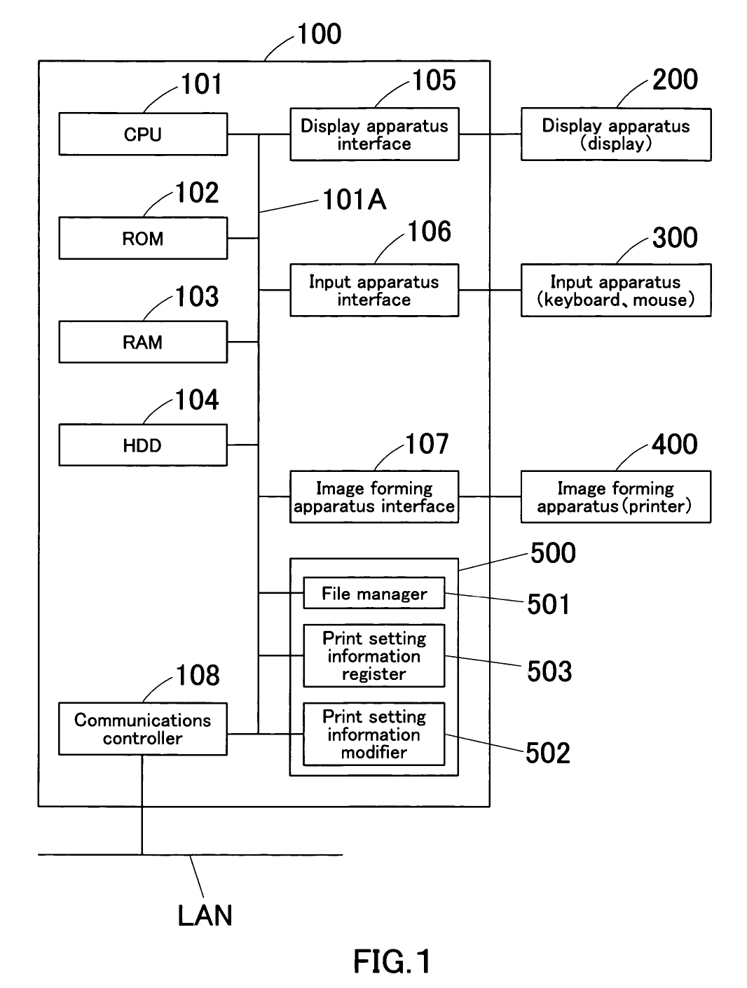

FIG. 1 is a block diagram showing an electrical arrangement including a terminal apparatus associated with an apparatus of automatically modifying print settings according to one embodiment of the present invention and its peripheral apparatuses. This embodiment involves transmitting and receiving the data as an attached file to the e-mail.

A terminal apparatus denoted by 100 in FIG. 1 may be a personal computer. The terminal apparatus 100 is connected with a display apparatus 200, an input apparatus 300, and an image forming apparatus 400.

The display apparatus 200 may be any applicable display device such as a liquid crystal display (LCD) or a CRT.

The input apparatus 300 may be a keyboard or a mouse not shown. The input apparatus 300 allows a user to set and command the actions of saving files, printing, transmitting mails, specifying data, assigning a receiver, and determining register modes and other processes.

The image forming apparatus 400 may be a printer or a multi-function peripheral (MFP) provided with printer and scanner functions.

The terminal apparatus 100 includes a CPU 101 connected via a bus 101A with a ROM 102, a RAM 103, a hard disk drive (HDD) 104, a display interface 105, an input interface 106, an image forming interface 107, a communications controller 108, and a file print setting information unit 500.

The CPU 101 is provided for controlling the entire actions of the terminal apparatus 100. The ROM 102 is a memory where action programs for the CPU 101 are stored. The RAM 103 is a memory for providing a working area of the CPU 101.

The HDD 104 is provided in which a mailer program is stored as an application program for transmitting and receiving e-mails. The mailer program is downloaded from the HDD 104 and loaded to the RAM 103 by a commanding action on the display screen of the display apparatus 200. The mailer program makes the CPU 101 execute the e-mail controlling function, and the e-mail controlling screen is displayed on the display apparatus 200.

The communications controller 108 is provided for functioning as a network interface to communicate with external apparatuses over a network such as LAN.

The print setting information unit 500 includes a file manager 501, a print setting modifier 502, and a print setting information register 503.

The file manager 501 is provided for examining whether or not the e-mail is accompanied with an attached file such as an image data when the e-mail is transmitted or received.

The print setting information modifier 502 is provided for examining whether or not the print setting information included in the attached file are equal to the print setting information preliminarily registered to the print setting information register 503 and if not, modifying the print setting information in the attached file to the registered print setting information at predetermined timing.

The print setting information register 503 is provided in which the print setting information is registered in advance. The registration may be carried out by a user operation with the input apparatus 300.

In this terminal apparatus 100, in action of transmitting the e-mail, a user prepares a text of the e-mail and sets a receiver and an attached file through operating the input apparatus 300 such as a keyboard while viewing the e-mail operation screen of the display apparatus 200 based on its mailer program.

The e-mail prepared by the user is saved in the RAM 103 and transmitted to the receiver over a communications network such as LAN by the communications controller 108 according to a relevant protocol.

In the action of receiving the e-mail, as its arrival is confirmed by the communications controller 108, the e-mail is received and saved in the RAM 103.

As the e-mail operation screen of the display apparatus 200 has been evoked by the mailer program of the terminal apparatus 100, the text of the e-mail received is displayed on the screen.

Simultaneously, an attached file assigned to the e-mail is saved in the RAM 103 by the action of the communications controller 108.

The attached file may be saved in the HDD 104 or an external storage (not shown) connected with LAN by the user's operation with the input operation via the operation screen of the display apparatus 200.

The content of the attached file is also displayed on the screen of the display apparatus 200 by an application program (a word processor or a spreadsheet software) for displaying the contents of the attached file. The application program is started by the user's operation via the operation screen of the display apparatus 200 based on the mailer program, or by user's instruction for executing the attached file directly after saving the file in the HDD 104.

When the contents of the attached file displayed on the display apparatus 200 may be printed by the image forming apparatus 400, their printing area has been determined by the operation via the operation screen displayed based on the application program. Alternatively, the print setting information may be entered from the print setting information input screen on the display apparatus 200 by the action of starting of a printer driver installed in the terminal apparatus 100.

The print setting information indicates various settings for the printing functions of the image forming apparatus 400, including the number of prints, determining between double side printing and single side printing, the tray number carrying sheets of printing paper, the post action such as stapling or folding, the colors of the image, the gradation level, and the rate of magnification or reduction in size.

The print setting information is assigned to the attached file and saved by the operation according to the application program. More particularly, the saved print setting information is incorporated into the data area of the attached file.

When the printing action is demanded by the user's operation through the operation screen displayed based on the application program, the data in the attached file are converted by the printer driver into print data according to the print setting information and transferred via the image forming interface 107 to the image forming apparatus 400.

The image forming apparatus 400 then receives the print data from the terminal apparatus 100 to conduct the printing action with reference to the print setting information.

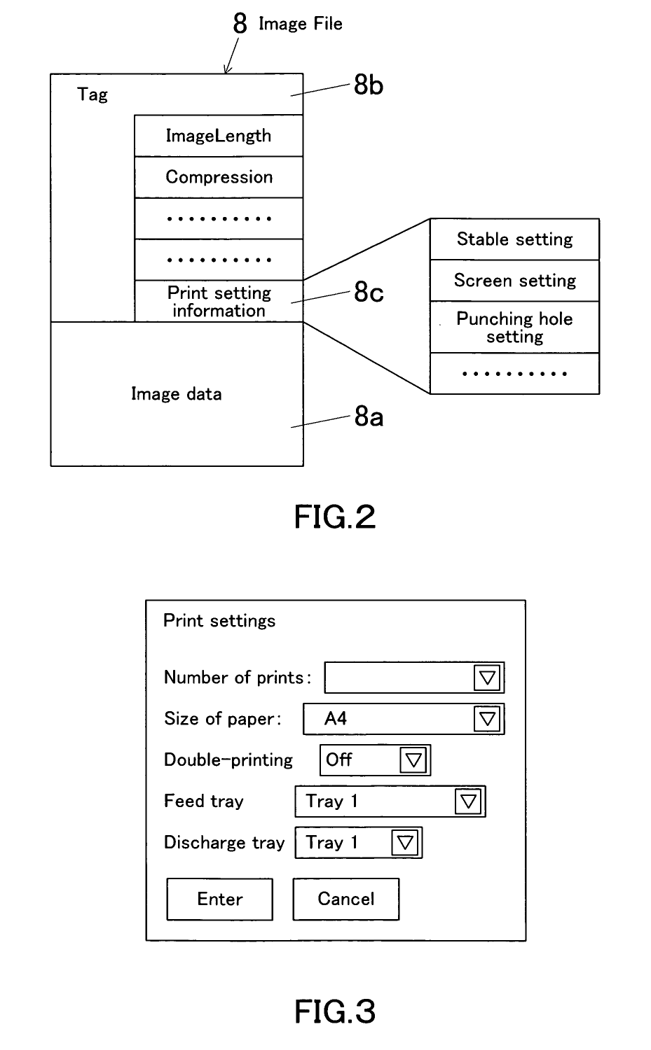

FIG. 2 illustrates a construction of a data file in which the print setting information is carried with the data. In this example, the file data is an image data while the data file is an image file.

The image file, for example, may be constructed in a TIFF (Tagged Image File Format) mode having a tag region 8b corresponding to an image data 8a. The tag region 8b is provided for carrying the size of the image data (image length), the compression type, and so on. The tag region 8b includes a print setting information tag 8c where the print setting information is described.

The image file 8 may be provided in form of pages when the image file 8 of the TIFF format is generated after scanning originals of paper sheet. Therefore, electrical data of a series of originals are saved as an independent image file 8 respectively. The print setting information tag 8c is hence adapted for carrying the information associated to a series of image files, for example, the prints being bound in groups, printed on both sides, or punched. As shown in FIG. 2, the print setting information includes a setting of a stapling of multiple originals, a double-side printing, a pattern of punching, and so on. The print setting information is intended not to be so limited.

The terminal apparatus 100 and the image forming apparatus 400 enable to analyze the print setting information tag 8c in the image file 8 for extracting the print setting information. Each image file prepared by the application software can be accompanied with the print setting information tag 8c for carrying print setting information which are produced by the application software and examined by the receiver.

The control of modifying the print setting information of the data will now be described in as example in which the data are transmitted or received as an attached file of the e-mail.

In the case that an image data, for example, is transmitted and received as the attached file of the e-mail, the print setting information of the image data is set by the application program of the terminal apparatus 100 for operating the attached file, and the print setting information is incorporated into the attached file.

Depending on the application, when the data is transmitted and received as the attached file of the e-mail, the print setting information may directly be transmitted and received in the saved form in the attached file.

It is assumed in this embodiment that the print setting information saved in the attached file of the e-mail is not needed at the receiver side. The print setting information is controlled to be replaced by print setting information registered with the terminal apparatus 100 of the receiver side.

First, the receiver or user has to register the print setting information to the print setting information register 503 in advance.

FIG. 3 illustrates an input screen on the display apparatus 200 for inputting the print setting information. When the user starts a register mode with the input apparatus 300, the print setting dialog (input) screen shown in FIG. 3 appears. This allows the user to fill the blanks of the number of prints, the size of printing paper, the double-side printing, the type of paper feed tray, and the type of paper exit tray. Alternatively, the input may be performed by selecting the item in the form of a pull-down menu. Then, the print setting information is registered into the print setting information register 503 by “pressing” the “enter” button. If the “cancel” button is “pressed”, the register mode will be canceled.

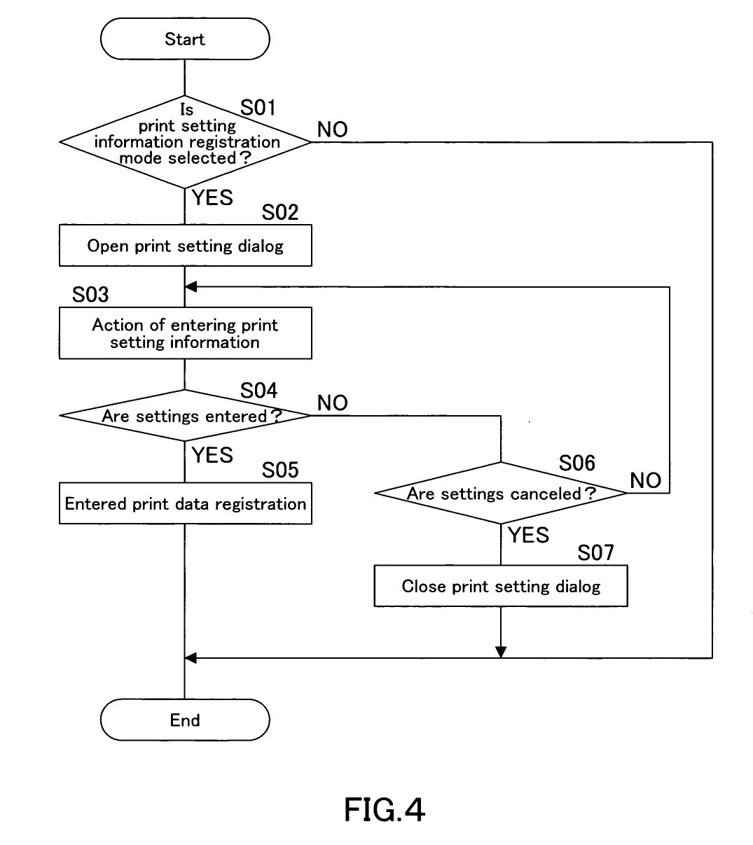

FIG. 4 is a flowchart showing a procedure of registering the print setting information into the print setting information register 503.

The procedure starts with Step S01 for examining whether or not the print setting information registering mode is selected by the user operation with the input apparatus 300. When so (YES at Step S01), the routine goes to Step S02 where the input screen shown in FIG. 3 is opened. When not (NO at Step S01), the procedure is terminated.

Then at Step S03, each item of the print setting information is entered by the user. It is then examined at Step S04 whether the “enter” button is “pressed” or not. When not (NO at Step S04), the routine goes to Step S06 for examining whether the “cancel” button is “pressed” or not. When the “cancel” button is not “pressed” (NO at Step S06), the routine returns back to Step S03.

When the “enter” button is “pressed” (YES at Step S04), the routine goes to Step S05 where the entered print setting information is registered into the print setting information register 503 and then this procedure is terminated. When the “cancel” button is pressed (YES at Step S06), the routine goes to Step S07 for closing the input screen before this procedure is terminated.

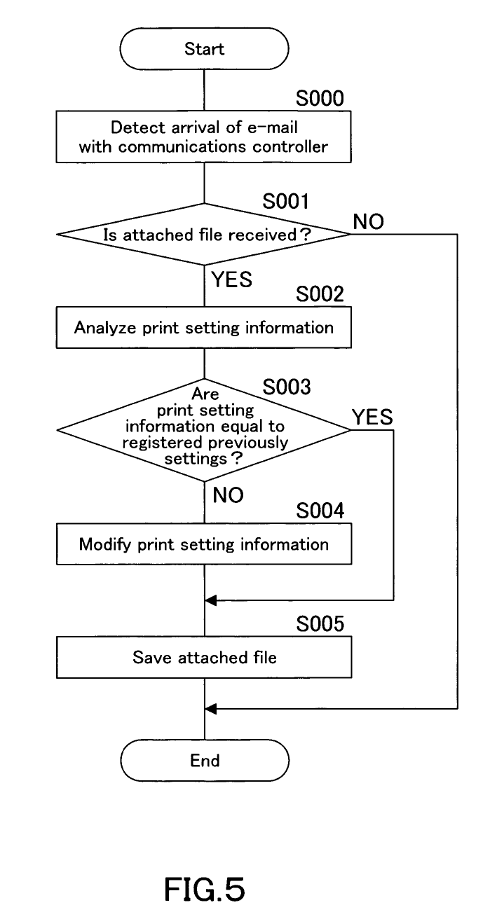

FIG. 5 is a flowchart showing the procedure of modifying the print setting information which is performed at the time of receiving the e-mail accompanied with an attached file.

As shown in FIG. 5, the routine starts with Step S000 for the terminal apparatus 100 detecting the arrival of the e-mail through the communications controller 108. It is then examined by the file manager 501 at Step S001 whether or not the e-mail is accompanied with an attached file.

When no file is attached (NO at Step S001), the procedure is directly terminated.

When the file is attached (YES at Step S001), the routine moves to Step S002 where the print setting information saved in the attached file with the file data is extracted by the print setting information modifier 502 and the routine goes to Step S003.

It is then examined at Step S003 whether or not the extracted print setting information is equal to the print setting information desired by the receiver and registered previously into the print setting information register 503. When the print setting information is not equal to the print settings registered previously in the terminal apparatus 100 (NO at Step S003), the routine goes to Step S004 for the print setting information modifier 502 modifying the print setting information to be equal to the print settings registered in the terminal apparatus 100 before advances to Step S005.

At Step S005, the attached file is recorded (saved) in a storage area (data storage area) specified by the mailer program of the terminal apparatus and the procedure is terminated.

When it is judged at Step S003 that the print setting information is equal to the print settings registered previously (YES at S003), no modification of the print setting information is required and the routine jumps to Step S005 for saving the file in the storage area specified by the mailer program before the procedure is terminated.

For starting the action of printing the data in the attached file, the receiver specifies the data and instructs printing the data to the image forming apparatus 400. The image forming apparatus 400 receives the data and the print setting information, and conducts the printing action according to the print setting information.

In this embodiment, even if the print setting information of the data received as the attached file of the e-mail is different from the desired print setting information for receiver registered in advance, it is automatically modified to be equal to the print setting information registered. As the result, an extra action of modifying the print setting information by the receiver will not be needed but the action of printing is carried out according to the print setting information without being conscious of the print setting information, thus ensuring the higher convenience of the receiver.

The print setting information registered previously are not limited to those determined by the receiver but may be default settings previously registered in the terminal apparatus 100. For example, the terminal apparatus 100 is installed with a printer driver for transmitting the image data to the image forming apparatus 400 and the default print setting information of the terminal apparatus 100 may be determined from the print setting information of the printer driver. Alternatively, as two or more image forming apparatuses 400 are registered in the terminal apparatus 100, the default print setting information of the terminal apparatus 100 are determined from the print setting information of one at the first priority of the image forming apparatuses 400.

In this case, the receiver can instruct printing the data without being conscious of the print setting information and the action of printing the data can be conducted according to the print setting information.

The embodiment shown in FIG. 5 indicates the case that the print setting information of the data included in the attached file is modified at the timing of receipt of the e-mail. The print setting information may be modified at the timing of saving the attached file (data) in the storage, such as the HDD 108, specified by the mailer program.

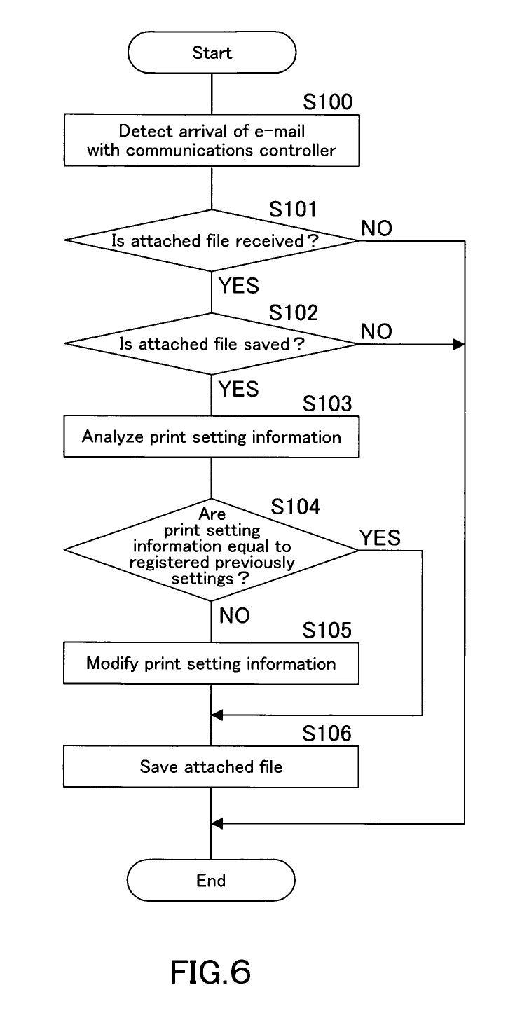

The procedure of modifying the print setting information at the timing of saving the attached file in the storage will now be described referring to a flowchart shown in FIG. 6.

As shown in FIG. 6, the routine starts with Step S100 for the terminal apparatus 100 detecting the arrival of the e-mail through the communications controller 108. It is then examined by the file manager 501 at Step S101 whether or not the e-mail is accompanied with an attached file.

When no file is attached (NO at Step S101), the procedure is directly terminated.

When the e-mail is attached with an attached file (YES at Step S101), the routine goes to Step S102 for examining whether or not a command for saving the attached file is released by the receiver.

When no command for saving the attached file is released (NO at Step S102), the procedure is terminated.

When a command for saving the attached file is released (YES at Step S102), the routine goes to Step S103 for analyzing the print setting information saved included with a file data in the attached file and goes to Step S104.

Based on the result of analyzing, it is examined at Step S104 whether or not the print setting information saved in the attached file are equal to the print setting information predetermined by the receiver and registered into the print setting information register 503. When the print setting information in the data are not equal to the settings registered previously into the print setting information register 503 (NO at Step S104), the routine goes to Step S105 for modifying the print setting information to be equal to the print setting information registered previously into the print setting information register 503 by the print setting information modifier 502 before advances to Step S106. When the print setting information in the data are equal to the registered print setting information (YES at Step S104), it need not to be modified and the routine jumps to Step S106.

At Step S106, the attached file is recorded (saved) in the storage area (data storage area) specified by the mailer program in the terminal apparatus 100 and the procedure is terminated.

For starting the action of printing the data in the saved attached file, the receiver commands the image forming apparatus 400 to print by specifying the data. In response, the image forming apparatus 400 receives the data and the print setting information to be transmitted from the terminal apparatus 100 and conducts the printing action according to the print setting information.

In this manner, the embodiment shown in FIG. 6 allows the print setting information to be automatically modified to the print setting information registered previously as timed with being saved in the storage area such as in the HDD 108. As the result, the data of which the print setting information should be modified is limited to the data saved in, e.g., the HDD 108. It will be avoidable to modify any redundancy of the print setting information which are assigned to other data not to be saved.

Since the print setting information of the data saved in the HDD 108 has been modified to the desirable print setting information for the receiver, the printing action will favorably be carried out with the receiver concerning no further modification of the print setting information.

Also, the action of modifying the print setting information is not limited to being timed with the arrival of the e-mail or the saving of the data in the storage but may be conducted at the timing of the image forming apparatus 400 receiving a command for starting the printing action.

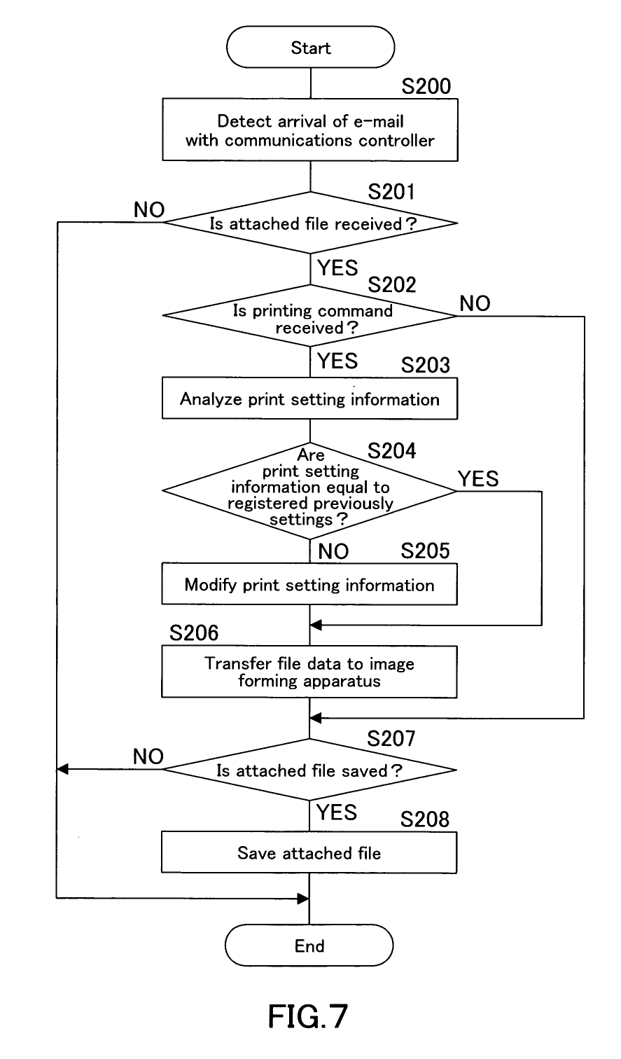

FIG. 7 is a flowchart showing the procedure of the above described action.

Referring to FIG. 7, the routine starts with Step S200 for the terminal apparatus 100 detecting the arrival of the e-mail with the communications controller 108. It is then examined by the file manager 501 at Step S200 whether or not the e-mail is accompanied with an attached file.

When no file is attached (NO at Step S201), the procedure is directly terminated.

When the file is attached to the e-mail (YES at Step S201), the routine goes to Step S202 for examining whether or not a command for starting the action of printing a data saved in the attached file is released by the receiver.

When no command is released (NO at Step S202), the routine jumps to Step S207. When the command for starting the printing action is released (YES at Step S202), the routine goes to Step S203 where the print setting information modifier 502 analyzes the print setting information saved together with the file data in the attached file and then advances to Step S204.

Based on the result of analyzing, it is examined at Step S204 whether or not the print setting information is equal to the print setting information registered into the print setting information register 503 and intended by the user. When the print setting information is not equal to the print settings (NO at Step S204), the routine goes to Step S205 where the print setting information modifier 502 modifies the print setting information to be equal to the print settings registered into the print setting information register 503 before advances to Step S206. When the print setting information is equal to the print setting information (YES at Step S204), the modification is not required and the routine goes advanced to Step S206.

At Step S206, the print data on the basis of the print setting information is transferred to the image forming apparatus 400. This allows the image forming apparatus 400 to conduct an action of printing according to the modified print setting information.

It is then examined at Step S207 whether or not a command for saving the attached file (data) is released by the receiver. When so (YES at Step S207), the routine goes to Step S208 for saving the attached file in a storage area specified by the mailer program in the terminal apparatus 100 before the procedure is terminated. When no command for saving the attached file is released (NO at Step S207), the procedure is directly terminated.

The embodiment shown in FIG. 7 allows the print setting information to be automatically modified to the registered print setting information at the timing of receipt of the command for starting the printing action. As the result, the data of which the print setting information should be modified is limited to the data to be printed. It will be avoidable to modify any redundancy of the print setting information which are assigned to other data not to be printed.

Since the print setting information of the data to be printed has been modified to the desirable print setting information for receiver, the printing action will favorably be carried out with the receiver concerning no further modification of the print setting information.

The embodiment shown in FIG. 7 allows the attached file to be printed prior to being saved. Alternatively, the print setting information may be modified only when the attached file has been saved in the storage and the data is desired to be printed.

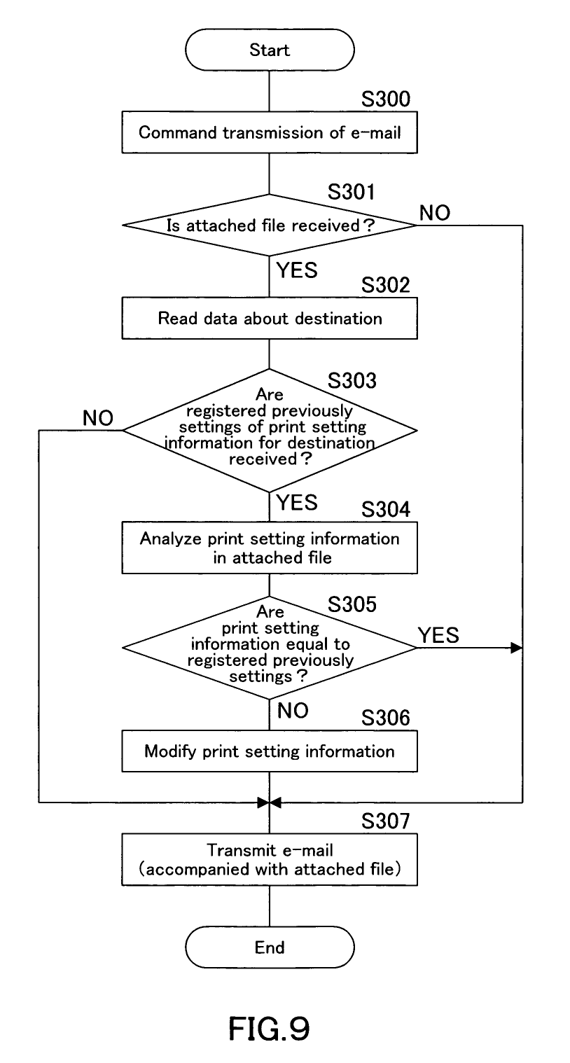

A procedure for modifying the print setting information at the time when the attached file carried in the e-mail is transmitted will now be described referring to a flowchart shown in FIG. 9.

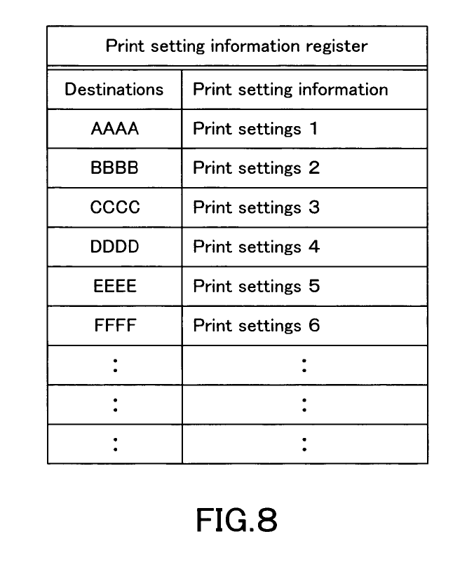

It is assumed in this procedure that the print setting information assigned to each destination have been registered into the print setting information register 503, as shown in FIG. 8.

Referring to FIG. 9, the procedure starts with Step S300 for the terminal apparatus 100 producing a command for transmitting the e-mail. It is then examined by the file manager 501 at Step S301 whether or not the e-mail is accompanied with an attached file.

When the file is attached to the e-mail (YES at Step S301), the routine goes to Step S302 for reading out an information of the destination to which the e-mail is transmitted. It is then examined at Step S303 whether or not the print setting information assigned to the destination have been registered into the print setting information register 503. When so (YES at Step S303), the routine goes to Step S304. When the print setting information have not been registered (NO at Step S303), the routine jumps to Step S307. Similarly, when it is judged at Step S301 that the file is not attached (NO at Step S301), the routine jumps to Step S307.

At Step S304, the print setting information assigned to a data saved in the attached file of the e-mail are analyzed by the print setting information modifier 502 before the routine goes to Step S305.

It is then examined at Step S305 whether or not the print setting information of the data are equal to the print setting information of the destination registered previously into the print setting information register 503. The print setting information registered previously represent the print setting information intended by the receiver to which the e-mail is transmitted.

When the print setting information of the data are not equal to the print setting information of the destination registered into the print setting information register 503 (NO at Step S305), the routine goes to Step S306 where the print setting information is modified by the print setting information modifier 502 to be equal to the receiver's settings which have been registered into the print setting information register 503. Then, the routine goes to Step S307. When the print setting information is equal to the receiver's print setting information (YES at Step S305), no modification is required and the routine directly goes to Step S307.

At Step S307, in response to a command produced by the mailer program in the terminal apparatus 100, the e-mail accompanied with the attached file are transmitted by the action of the communications controller 108 to a communications network such as LAN.

When intends to print down the attached file of the e-mail received, the receiver supplies the image forming apparatus 400 with a command for starting the printing action while specifying the data to be printed. The image forming apparatus 400 then receives the data together with the print setting information from the terminal apparatus 100 and starts the action of printing the data according to the print setting information.

In the embodiment shown in FIG. 9, even if the print setting information of the data to be transmitted as the attached file of the e-mail by the terminal apparatus 100 is different from the print setting information preliminarily registered into the print setting information register 503 in response to the destination, it is automatically modified to be equal to the registered print setting information. As the result, an extra action of modifying the print setting information by the receiver will not be needed but the action of printing is carried out according to the print setting information without being conscious of the print setting information, thus ensuring the higher convenience of the receiver.

The print setting information registered previously may be default settings previously registered in the terminal apparatus 100. For example, the terminal apparatus 100 is installed with a printer driver for transmitting the print data to the image forming apparatus which is commonly selected and used, and its default print settings may be determined from the print setting information of the printer driver.

In this case, the receiver of the destination can print the data according to the default print settings.

In the embodiment shown in FIG. 9, the print setting information included in the attached file to be modified as timed with the transmission of the e-mail. Alternatively, the print setting information may be modified at the timing of reading out the data from the storage such as the HDD 108 for attaching the data file to the e-mail.

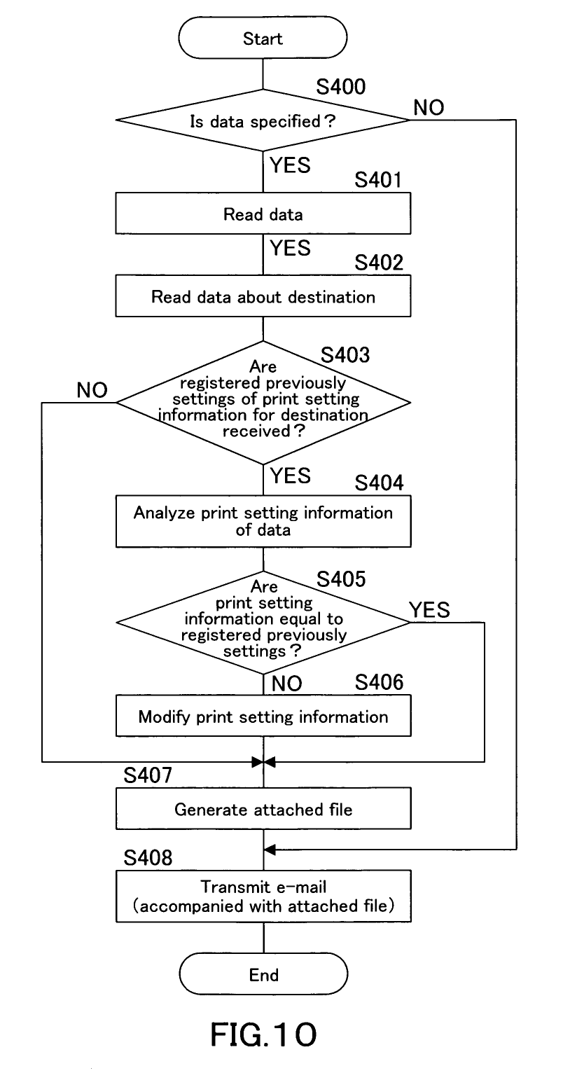

A procedure of the above modifying action will now be described referring to a flowchart shown in FIG. 10.

The procedure starts with a user at the transmitter side preparing the text of the e-mail to be transmitted to a desired receiver and selecting a data, which is to be read out from the storage such as the HDD 104 and attached as the attached file to the e-mail, through turning on the attached file button. This action is detected at Step S400 shown in FIG. 6 (YES at S400) and followed by Step S401 where the data is read out from the storage.

Then, the destination information of the e-mail is read out at Step S402 and it is examined at Step S403 whether or not the print setting information for the destination is registered into the print setting information register 503. When so (YES at Step S403), the routine goes to Step S404. When the print setting information is not registered (NO at Step S403), the routine jumps to Step S407.

At Step S404, the print setting information is analyzed by the print setting information modifier 502 and it is then examined at Step S405 whether or not the print setting information is equal to the print settings for the destination which have been registered into the print setting information register 503.

When the print setting information is not equal to the print settings data for the destination which is registered into the print setting information register 503 (NO at S405), the routine goes to Step S406 where the print setting information is modified by the print setting information modifier 502 to be equal to the settings for the destination which have been registered previously into the print setting information register 503 before advances to Step S407. When the print setting information of the data is equal to the print setting information for the destination which is registered previously (YES at S405), no modification is required and the previously directly goes to Step S407.

At Step S407, the data is saved and the attached file is produced. At Step S408, as the transmission of the e-mail is commanded by the mailer program in the terminal apparatus 100, the e-mail attached with the attached file are transmitted by the communications controller 108 to the communications network such as LAN.

When the attached file is not attached (NO at Step S400), the only text of the e-mail is transmitted at Step S406.

The embodiment shown in FIG. 10 allows the print setting information to be automatically modified to the print setting information for the destination registered previously at the timing of reading the data from the storage area for producing the attached file. As the result, the data of which the print setting information should be modified is limited to the data read out from the storage. It will be avoidable to modify any redundancy of the print setting information which are assigned to other data not to be read out.

As set forth above, one embodiment of the present invention is intended not to be limited. For example, while the action of modifying the print setting information is conducted by the terminal apparatus 100 connected with the display apparatus 200, the input apparatus 300, and the image forming apparatus 400 in the embodiment, an improvement of the image forming apparatus 400 equipped with the built-in components of the terminal apparatus 100, the display apparatus 200, and the input apparatus 300 and having a function of transmitting and receiving e-mails may be provided for carrying out the action of modifying the print setting information of a data to be received or transmitted. This allows the data of which the print setting information have been modified to be received by a printer installed in the image forming apparatus for conducting the printing action.

The timing when the print setting information is modified is not limited to that in the embodiment but may arbitrarily be determined before the transmission or after the receipt of a data.

The data of which the print setting information is modified is not limited to data to be received or transmitted in the attached file of the e-mail.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, procedure or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. An apparatus of automatically modifying print settings comprising:
a receiving portion for receiving data set with the print setting information;
a registering portion into which the print setting information is registered;
a print setting modifying portion for modifying the print setting information of the received data to the registered print setting information; and
a transmitting portion for transmitting the data of which the print setting information is modified by the print setting modifying portion to a printer.

2. The apparatus of automatically modifying print settings as recited in claim 1, further comprising
an examining portion for examining whether or not the print setting information of the received data is equal to the registered print setting information;
wherein
the print setting modifying portion modifies the print setting information of the data to the registered print setting information when it is judged by the examining portion that the print setting information of the received data is not equal to the registered print setting information.

3. The apparatus of automatically modifying print settings as recited in claim 1, wherein
the registered print settings information is an initial print setting information.

4. The apparatus of automatically modifying print settings as recited in claim 1, wherein
the print setting modifying portion modifies the print setting information at a timing of receipt of the data.

5. The apparatus of automatically modifying print settings as recited in claim 1, wherein
the print setting modifying portion modifies the print setting information at a timing of saving of the received data into predetermined storage.

6. The apparatus of automatically modifying print settings as recited in claim 1, wherein
the print setting modifying portion modifies the print setting information at a timing of release of a command for printing the data with the printer.

7. The apparatus of automatically modifying print settings as recited in claim 1, wherein
the apparatus of automatically modifying print settings is implemented by an image forming apparatus in which the printer is installed.

8. The apparatus of automatically modifying print settings as recited in claim 1, wherein
the data is received in the form of an attached file of an e- mail.

9. The apparatus of automatically modifying print settings as recited in claim 8, wherein
the print setting information of the data is saved in the attached file in which the data is saved.

10. An apparatus of automatically modifying print settings comprising:
a registering portion into which the print setting information for a destination is registered;
a print setting modifying portion for modifying the print setting information of data to be transmitted to the destination to the registered print setting information for the destination; and
a transmitting portion for transmitting the data of which the print setting information is modified by the print setting modifying portion to an external apparatus at the destination.

11. The apparatus of automatically modifying print settings as recited in claim 10, further comprising
an examining portion for examining whether or not the print setting of the data to be transmitted to the destination is equal to the registered print setting information for the destination;
wherein
the print setting modifying portion modifies the print setting information to the registered print setting information when it is judged by the examining portion that the print setting information of the data to be transmitted to the destination is not equal to the registered print setting information for the destination.

12. The apparatus of automatically modifying print settings as recited in claim 11, wherein
the registered print setting information is an initial print setting information determined at the destination.

13. The apparatus of automatically modifying print settings as recited in claim 11, wherein
the print setting modifying portion modifies the print setting information at the timing of the release of a command for transmitting the data to the destination.

14. The apparatus of automatically modifying print settings as recited in claim 11, wherein
the print setting modifying portion modifies the print setting information at the timing of the action of reading the data from the predetermined storage.

15. The apparatus of automatically modifying print settings as recited in claim 11, wherein
the apparatus of automatically modifying print settings is implemented by an image forming apparatus.

16. The apparatus of automatically modifying print settings as recited in claim 11, wherein
the data is transmitted in the form of an attached file of the e-mail.

17. The apparatus of automatically modifying print settings as recited in claim 16, wherein
the print setting information of the data is saved in the attached file in which the data is saved.

18. A method of automatically modifying print setting comprising the steps of:
receiving data set with the print setting information;
modifying the print setting information of the received data to the print setting information which is registered into a registering portion; and
transmitting the data of which the print setting information is modified to a printer.

19. A method of automatically modifying print setting as recited in claim 18, further comprising the step of
examining whether or not the print setting information of the received data is equal to the registered print setting information;
wherein
when it is judged that the print setting information of the received data is not equal to the registered print setting information, the print setting information of the data is modified to the registered print setting information.

20. A method of automatically modifying print setting comprising the steps of:
modifying the print setting information of data to be transmitted to a destination to a print setting information for the destination which is registered into a registering portion; and
transmitting the data of which the print setting information is modified to the destination.

21. A method of automatically modifying print setting as recited in claim 20, further comprising the step of
examining whether or not the print setting information of the data to be transmitted to the destination is equal to the registered print setting information for the destination;
wherein
when it is judged that the print setting information of the data to be transmitted to the destination is not equal to the registered print setting information, the print setting information of the data is modified to the registered print setting information.
